(19) United States
(12) Patent Application Publication
(10) Pub. No.: US 2002/0165015 A1
(43) Pub. Date: Nov. 7, 2002

(54) Incoming call information buffer system and method

(76) Inventor: Wen Biao Lee, Taipei Hsieng (TW)

Correspondence Address: BIRCH STEWART KOLASCH & BIRCH, PO BOX 747, FALLS CHURCH, VA, 22040-0747, US

(21) Appl. No.: 09/908,802

(22) Filed: Jul. 20, 2001

(30) Foreign Application Priority Data
May 2, 2001 (TW) 90110488

(51) Int. Cl. H04M 1/00

(52) U.S. Cl. 455/567; 455/458; 455/565

(57) ABSTRACT

An incoming call information buffer system includes an information database and a transmission module. The information database stores the information of an incoming call when the communications device being called is not able to receive the incoming call. The transmission module sends the information of the incoming call to the communications device when it is next turned on. The invention also provides an incoming call information buffer method.

### BACKGROUND OF THE INVENTION

1. Field of Invention

The invention relates to an incoming call information buffer system and, in particular, to a system, that can temporarily store relevant information about an incoming call when the communications device is not able to answer the incoming call.

2. Related Art

Normally, when a person makes a phone call to a communications device user, the communications service provider establishes a signal link between the caller telephone and the communications device so that both users can have a conversion. However, when the communications device being called is not able to answer the incoming call, for example, when the mobile communications device is busy, the communication service provider usually only notifies the caller that the connection has failed and asks the caller to leave a message. If the caller does not leave a message, the user of the communications device would not be able to know if there are any incoming calls when he is not able to use the device to answer the phone call.

Take a mobile phone user for example, a mobile phone is not able to answer an in coming call when the mobile phone is busy, the mobile phone is turned off, or the mobile phone is unable to receive a signal from the base station. Therefore, the mobile phone user is more likely to miss a phone call.

Therefore, to prevent missing phone calls, the communications device user has to keep the communications device in a state of being able to receive incoming calls at all times. This may not only disturb the sleep of the user but will also quickly drain the electrical power of the device. Furthermore, when the mobile communications device is in an ON state to accept incoming calls, it receives electromagnetic waves all the time in order to communicate with communications base stations. Such electromagnetic waves may have a harmful influence on humans' health; therefore, leaving the mobile communications device power on for a long time can have negative impact on the user.

### SUMMARY OF THE INVENTION

In response to the above problems, it is an objective of the invention to provide an incoming call information buffer system and the corresponding method, which can keep the information of incoming calls when the communications device is not able to receive incoming calls. Therefore, the user will not miss any important calls.

Another objective of the invention is to provide an incoming call information buffer system and the corresponding method, which can keep the information of incoming calls when the communications device is not able to receive incoming calls. Therefore, less electrical power will be wasted, as one does not need to keep the device turned on all off the time.

Yet another objective of the invention is to provide an incoming call information buffer system and the corresponding method, which can keep the information of incoming calls when the communications device is not able to receive incoming calls. Therefore, the damage to human health is reduce as electromagnetic waves can be minimized, as one does not need to keep the device turned on all off the time.

To achieve the above objectives, the incoming call information buffer system according to the invention includes an information database and a transmission module. The information database stores the information of an incoming call when the communications device being called is not able to receive the incoming call. The transmission module sends the information of the incoming call to the communications device when it is next turned on.

The invention also discloses an incoming call information buffer method, which first stores information about an incoming call to an information database when the communications device being called is not able to receive the phone call. When the communications device is turned on, a transmission module is employed to send the saved incoming information in the information database to the communications device.

The incoming call information buffer system and the incoming call information buffer method according to the invention achieve the goal that no calling information would be lost even if the communications device is not able to receive the incoming call. Therefore the user will not miss any important phone calls.

The incoming call information buffer system and the incoming call information buffer method according to the invention achieve the goal that no calling information would be lost even if the communications device is not able to receive the incoming call. Therefore less electrical power is consumed since the communications device can be turned off.

The incoming call information buffer system and the incoming call information buffer method according to the invention achieve the goal that no calling information would be lost even if the communications device is not able to receive the incoming call. Therefore the user will not miss any important phone calls. Therefore, the damage to human health due to electromagnetic waves can be minimized, as one does not need to keep the device turned on all off the time.

### BRIEF DESCRIPTION OF THE DRAWINGS

The invention will become more fully understood from the detailed description given hereinbelow illustration only, and thus are not limitative of the invention, and wherein:

FIG. 1 is a block diagram showing the structure of an incoming call information buffer system and the interaction among the system, the calling device, and the mobile communications device being called according to a preferred embodiment of the invention;

FIG. 2 is a schematic view showing the incoming call information stored in the information database; and

FIG. 3 is a flowchart showing the procedure of implementing the incoming call information buffer method according to the preferred embodiment of the invention.

### DETAILED DESCRIPTION OF THE INVENTION

The invention will be apparent from the following detailed description, which proceeds with reference to the accompanying drawings, wherein the same references relate to the same elements.

With reference to FIG. 1, the incoming call information buffer system 1 according to a preferred embodiment of the invention includes a receiving module 11, a searching module 12, a conversation module 13, an information database 14, and a transmission module 15. The receiving module 11 receives incoming call information 141 transmitted from a calling device 2. The calling device 2 can be a GSM (Global System for Mobile Communication) mobile station. The searching module 12 searches the communications device being called according to the incoming call information 141. In the embodiment, the communications device being called can be a mobile communications device 3, such as another GSM mobile station. If the mobile communications device 3 is in a state that is able to accept incoming calls, the conversation module 13 then establishes a connection between the calling device 2 and the mobile communications device 3 being called. If the searching module 12 finds that the mobile communications device 3 is in a state of not being able to accept incoming calls, the incoming call information 141 is then sent to the information database 14 to be stored. In the preferred embodiment, the situations of the mobile communications device 3 not being able to accept incoming calls may include: the mobile communications device 3 being turned off, the mobile communications device 3 being not to receive any signals, and the lines being busy. The transmission module 15 transmits the incoming call information 141 to the mobile communications device 3 being called as soon as it is in an available state to accept incoming calls.

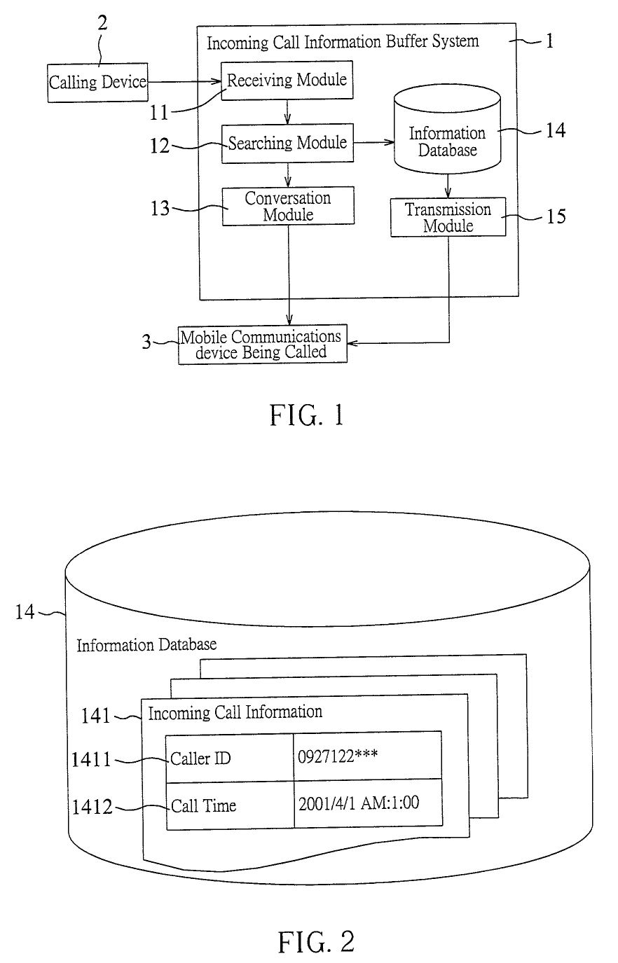

As shown in FIG. 2, the incoming call information 141 stored in the information database 14 includes a caller ID 1411 and a call time 1412. When the mobile communications device 3 is available to receive phone calls, the transmission module 15 immediately sends the incoming call information 141 to the mobile communications device 3, and the mobile communications device 3 obtains the information about the caller ID 1411 and the call time 1412. Therefore, through the incoming call information 141, the mobile communications device user can still know whether there have been any important phone calls during the time when the mobile communications device 3 is not able to receive phone calls. The user can then decide whether he needs to return the phone call using the incoming call information 141.

In the prior art, when a mobile communications device 3 is turned off, it is not able to know whether there are any incoming phone calls. However, the incoming call information buffer system 1 according to the invention stores the incoming call information 141 received by the receiving module 11 in an information database 14 when the mobile communications device being called is not able to receive any signal. The transmission module 15 then transmits the incoming call information 141 to the mobile communications device 3 at the next time it is in the network for receiving calls. Therefore, no phone call will be missed even when the mobile communications device 3 is turned off, receives no signal, or is busy. In other words, the mobile communications device 3 being called does not need to be always in a state of being able to receive phone calls to avoid missing any phone call. Therefore, the problem of missing phone calls when the mobile communications device is not able to receive calls is thus solved.

To make the content of the invention more comprehensible, a preferred embodiment is given hereinafter to illustrate the incoming call information buffer system.

The above-mentioned incoming call information buffer system 1 can be applied to various wireless communications system. Taking the GSM mobile station communications system as an example, if the caller calls a GSM mobile station via the PSTN, the PSTN exchanger first transmits the MSISDN (Mobile Station ISDN Number) that the user dials to a GMSC (Gateway Mobile Switching Center). After the MSISDN is decoded by the GMSC, an HLR (Home Location Register) is obtained to find the VLR (Visitor Location Register) and hence where the mobile station is located. Afterwards, the VLR is used to search for the MSRN (Mobile Station Roaming Number) of the mobile station and the MSRN is sent back to the GMSC via the HLR. GMSC then establishes a signal connection with the MSC (Mobile Switching Center) of the area where the mobile station is located in accordance with the MSRN, thus establishing the signal connection between the phone device of the caller and the mobile station.

Whether the caller is using a DTMF (Dual-Tone Multiple Frequency) or a FSK (Frequency Shift Keying) dial method, the caller ID can always be transmitted via the PSTN and a wireless network. Therefore, even if the mobile station is busy, or is turned off so that its VLR cannot be found, the caller ID is always transmitted to the MSC. Consequently, both the information database 14 and the transmission module 15 can be implemented in a MSC in the embodiment so as to obtain the caller ID and a caller ID transmission time. The caller ID and the caller ID transmission time can be the caller ID 1411 and the call time 1412, respectively. In addition, the transmission module 15 can transmits the incoming call information 141 in a short message method or using any data transmission protocol.

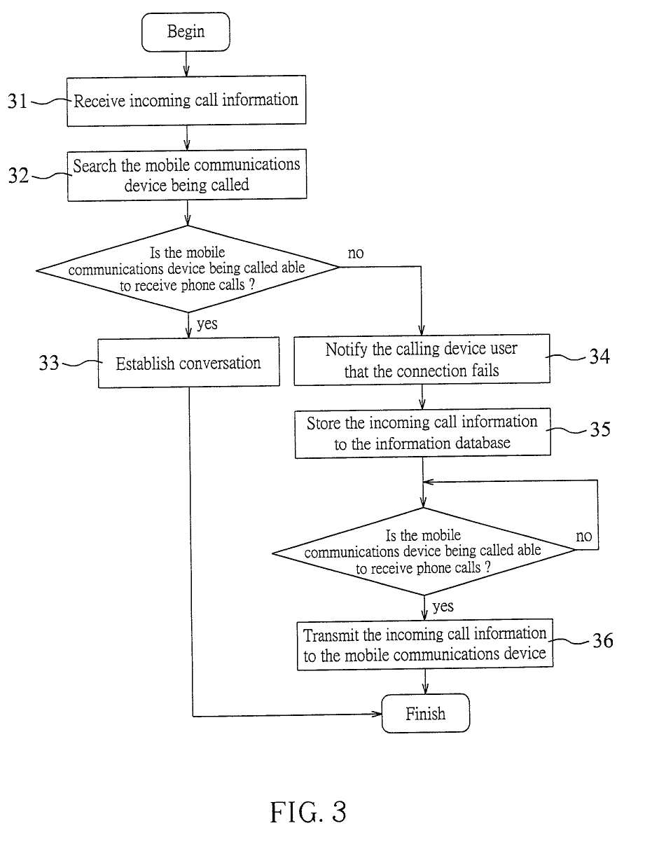

With reference to FIG. 3, the incoming call information buffer method according to the invention receives incoming call information 141 from a calling device 2 in step 31. In step 32, the incoming call information 141 is used to search for the communications device being called, such as a mobile communications device 3. Since the calling procedure of the mobile communications device is known to any person skilled in the art and has been described before, it is not repeated hereinafter.

The method then determines whether the mobile communications device 3 is available for receiving incoming calls. If the mobile communications device 3 is available for receiving incoming calls, step 33 starts to establish the conversation between the calling device 2 and the mobile communications device 3. If the mobile communications device 3 is not available for receiving incoming calls, step 34 notifies the user of the calling device 2 that the connection fails. In step 35, the incoming call information 141 is stored in the information database 14. In particular, the incoming call information 141 contains the caller ID 1411 and the call time 1412, i.e. the caller ID and the caller ID transmission time.

When the mobile communications device 3 being called can receive incoming calls, the MSC will obtain the information that the mobile communications device 3 is online because it immediately connects to the closest base station to register his location in the VLR and the HLR. Thereafter, step 36 transmits the incoming call information 141 in the information database 14 to the mobile communications device 3 being called. The transmission method can be done via the well-known short message or using any data transmission protocol.

The system and method according to the invention does not miss any incoming call information when the mobile communications device being called is not able to receive phone calls. Therefore, the user can still return the phone calls he misses. The invention can also save electrical power because the user can safely turn off the mobile communications device, thus minimizing possible damage to the human body due to electromagnetic waves.

The communications device being called in the invention can as well be an ordinary telephone, i.e. the communications device used in a PSTN. In particular, the information database and the transmission module can be implemented in the exchanger of the PSTN or a server.

The invention being thus described, it will be obvious that the same may be varied in many ways. For example, the information database and the transmission module can be integrated into a server or an MSC. Such variations are not to be regarded as a departure from the spirit and scope of the invention, and all such modifications as would be obvious to one skilled in the art are intended to be included within the scope of the following claims.

What is claimed is:

1. An incoming call information buffer system comprising:
an information database, which stores incoming call information when a communications device being called is not able to receive phone calls; and
a transmission module, which transmits the incoming call information to the communications device being called when the communications device being called is able to receive phone calls.

2. The system of claim 1, wherein the communications device being called is a communications device used in PSTN (public switched telephone network).

3. The system of claim 1, wherein that the communications device being called is not able to receive phone calls means that the communications device being called is turned off.

4. The system of claim 1, wherein that the communications device being called is not able to receive phone calls means that the communications device being called is busy.

5. The system of claim 1, wherein the incoming call information contains a caller ID and a call time.

6. The system of claim 1, wherein the communications device being called is a mobile communications device.

7. The system of claim 6, wherein that the mobile communications device is not able to receive phone calls means that the mobile communications device is outside of the network.

8. The system of claim 6, wherein the transmission module in the mobile communications device is to transmit the incoming call information to the mobile communications device by SMS (short message service).

9. An incoming call information buffer method, which comprises the steps of:
storing incoming call information to an information database when a communications device being called is not able to receive phone calls; and
transmitting the incoming call information in the information database to the communications device being called when the communications device being called is able to receive phone calls.

10. The method of claim 9, wherein the communications device being called is a communications device used in PSTN (public switched telephone network).

11. The method of claim 9, wherein that the communications device being called is not able to receive phone calls means that the communications device being called is turned off.

12. The method of claim 9, wherein that the communications device being called is not able to receive phone calls means that the communications device being called is busy.

13. The method of claim 9, wherein the incoming call information contains a caller ID and a call time.

14. The method of claim 9, wherein the communications device being called is a mobile communications device.

15. The system of claim 14, wherein that the mobile communications device is not able to receive phone calls means that the mobile communications device is outside of the network.

16. The system of claim 14, wherein the transmission module in the mobile communications device is to transmit the incoming call information to the mobile communications device by SMS (short message service).
